(19) United States
(12) Patent Application Publication
(10) Pub. No.: US 2025/0051202 A1
(43) Pub. Date: Feb. 13, 2025

(54) Systems and Methods for Controlling the Feed Rate of Chemicals into a Body of Water

(71) Applicant: clearwater1, inc., Milpitas, CA (US)

(72) Inventor: Robin Giguere, Piedmont, CA (US)

(21) Appl. No.: 18/925,883

(22) Filed: Oct. 24, 2024

Related U.S. Application Data
(63) Continuation of application No. 17/130,817, filed on Dec. 22, 2020, now abandoned.
(60) Provisional application No. 62/956,705, filed on Jan. 3, 2020.

(51) Int. Cl. C02F 1/76

(52) U.S. Cl. CPC C02F 1/76; C02F 2201/784; C02F 2209/29

(57) ABSTRACT

A method of controlling a feed rate of at least one chemical into a body of water includes: (a) dispensing one or more chemicals into a body of water with a chemical pumping device; (b) determining a chemical feed pump usage of at least one chemical into the body of water during a designated period of time; and (c) (i) automatically increasing chemical gain of the at least one chemical into the body of water if the pump usage is greater than a first pump usage set-point, or (ii) automatically decreasing chemical gain of the at least one chemical into the body of water if the pump usage is less than a second pump usage set-point. A system for using the method is also included.

### CROSS REFERENCE TO RELATED APPLICATIONS

This application is a continuation of U.S. Nonprovisional patent application Ser. No. 17/130,817 filed Dec. 22, 2020 which claims priority to U.S. Provisional Application No. 62/956,705 filed Jan. 3, 2020, which applications are herein incorporated by reference in their entirety.

### BACKGROUND

### Technical Field

The present disclosure relates to systems and methods for controlling the feed rate of chemicals into a body of water.

### Technical Considerations

Water utilities typically add disinfectants, such as chlorine and chloramine, to water systems to prevent contamination from germs and bacteria. However, the concentration of chemicals in water systems fluctuate over time. For instance, chlorine and chloramine concentration typically decrease over time due to natural decomposition and other factors such as temperature, pH, and biological activity. In order to address these changes in concentration, an operator must intervene to increase or decrease the feed rate of the chemicals.

In addition, it is generally better to run the chemical feed pump as slow as possible to address unexpected system failures and to provide a more gradual change in residual chemical concentration. While slow chemical feed rates provide various advantages, it is more difficult to address residual chemical demands at such slow feed rates. It is, therefore, ideal to establish a chemical feed rate that allows an operator to sufficiently address unexpected system failures and which also addresses changes in concentration.

Thus, it is desirable to provide a system and method for automatically controlling chemical feed rates for addressing unexpected system failures, as well as changes in chemical concentration.

### SUMMARY

In some non-limiting embodiments or aspects, provided is a method of controlling a feed rate of at least one chemical into a body of water comprising: (a) dispensing one or more chemicals into a body of water with a chemical pumping device; (b) determining a chemical feed pump usage of at least one chemical into the body of water during a designated period of time; and (c) (i) automatically increasing chemical gain of the at least one chemical into the body water if the pump usage is greater than a first pump usage set-point, or (ii) automatically decreasing the chemical gain of the at least one chemical into the body water if the pump usage is less than a second pump usage set-point.

In some non-limiting embodiments or aspects, the at least one chemical is chlorine. The designated period of time can also be selected from various periods of time, such as 24 hours, for example.

In some non-limiting embodiments or aspects, the chemical feed pump usage is determined from a percentage of time in which the chemical pumping device is running during the designated period of time. In some non-limiting embodiments or aspects, the first pump usage set-point is a predetermined upper limit percentage of the designated period of time. Further, in some non-limiting embodiments or aspects, the second pump usage set-point is a predetermined lower limit percentage of the designated period of time.

In some non-limiting embodiments or aspects, the chemical feed pump usage is determined from a total amount of chemical pumped during the designated period of time. In some non-limiting embodiments or aspects, the first pump usage set-point is a predetermined upper limit amount of the total chemical pumped during the designated period of time. Further, in some non-limiting embodiments or aspects, the second pump usage set-point is a predetermined lower limit of the total chemical pumped during the designated period of time.

In some non-limiting embodiments or aspects, the chemical feed pump usage is determined from an expected chemical gain in chemical concentration during the designated period of time. In some non-limiting embodiments or aspects, the first pump usage set-point is a predetermined upper limit amount of the expected chemical gain in chemical concentration during the designated period of time. Further, in some non-limiting embodiments or aspects, the second pump usage set-point is a predetermined lower limit amount of the expected chemical gain in chemical concentration during the designated period of time.

In some non-limiting embodiments or aspects, the chemical gain is increased by increasing a chemical feed rate of the at least one chemical in the body of water, and the chemical gain is decreased by decreasing the chemical feed rate of the at least one chemical in the body of water. In some non-limiting embodiments or aspects, the chemical feed rate of the at least one chemical is increased by a predetermined amount when the pump usage is greater than the first pump usage set-point. The chemical feed rate of the at least one chemical can also be decreased by a predetermined amount when the pump usage is less than the second pump usage set-point.

In some non-limiting embodiments or aspects, an amount in which the chemical feed rate of the at least one chemical is increased is determined by the following formula: F_{NEW}=MIN(F +DELTA_F_UP, F_MAX), in which F_{NEW} is the new chemical feed rate, F is the current chemical feed rate, DELTA_F_UP is the increase in the chemical feed rate, and F_MAX is the maximum chemical feed rate. In some non-limiting embodiments or aspects, an amount in which the chemical feed rate of the at least one chemical is decreased is determined by the following formula: F_{NEW}=MAX(F+DELTA_F_DOWN, F_MIN), in which F_{NEW} is the new chemical feed rate, F is the current chemical feed rate, DELTA_F_DOWN is the decrease in the chemical feed rate, and F_MIN is the minimum chemical feed rate.

In some non-limiting embodiments or aspects, the chemical feed rate is increased or decreased by an amount to provide a new chemical feed rate that is determined from the following formula: F_{NEW}=K*V/C, in which F_{NEW} is the new chemical feed rate, K is a desired chemical gain of the at least one chemical in the body of water, V is the water volume of the body of water, and C is the concentration of the bulk solution of chemical to the reservoir. The desired chemical gain can be determined by the following formula: K=K̅/SP %, in which K is the desired chemical gain, K̅ is an average chemical gain in the body of water over the designated period of time, and SP % is a desired % of pump usage over the designated period of time.

In some non-limiting embodiments or aspects, the method further comprises notifying an operator when the chemical feed rate of the at least one chemical is increased or decreased and/or when the at least one chemical should increase or decrease.

In some non-limiting embodiments or aspects, the present disclosure also includes a system for controlling a feed rate of at least one chemical into a body of water comprising: an assembly for delivering one or more chemicals into the body of water comprising at least one chemical feed pump; a water sampling assembly configured to extract water samples from the body of water at different points in time; an analyzer in fluid communication with the water sampling assembly; a controller in operable communication with the analyzer and the assembly for delivering one or more chemicals; and one or more computer-readable storage mediums in operable communication with the controller and containing programming instructions that, when executed, cause the controller to: (a) determine a chemical pump usage of at least one chemical into the body of water during a designated period of time; and (b) (i) automatically increase chemical gain of the at least one chemical in the body water if the pump usage is greater than a first pump usage set-point, or (ii) automatically decrease chemical gain of the at least one chemical in the body water if the pump usage is less than a second pump usage set-point.

The system can include any of the features of the previously described method. For example, in some non-limiting embodiments or aspects, the at least one chemical is chlorine and the designated period of time is 24 hours.

In some non-limiting embodiments or aspects, the analyzer comprises a total chlorine analyzer and/or free chlorine analyzer. In some non-limiting embodiments or aspects, the controller is configured to notify an operator when the chemical feed rate of the at least one chemical is increased or decreased and/or when the at least one chemical should increase or decrease.

Further non-limiting embodiments or aspects are set forth and described in the following clauses.

Clause 1: A method of controlling a feed rate of at least one chemical into a body of water comprising: a) dispensing one or more chemicals into a body of water with a chemical pumping device; b) determining a chemical feed pump usage of at least one chemical into the body of water during a designated period of time; and c) (i) automatically increasing chemical gain of the at least one chemical in the body of water if the pump usage is greater than a first pump usage set-point, or (ii) automatically decreasing chemical gain of the at least one chemical into the body water if the pump usage is less than a second pump usage set-point.

Clause 2: The method of clause 1, wherein the at least one chemical is chlorine.

Clause 3: The method of clauses 1 or 2, wherein the chemical feed pump usage is a percentage of time in which the chemical pumping device is running during the designated period of time.

Clause 4: The method of any of clauses 1-3, wherein the first pump usage set-point is a predetermined upper limit percentage of the designated period of time.

Clause 5: The method of any of clauses 1-3, wherein the second pump usage set-point is a predetermined lower limit percentage of the designated period of time.

Clause 6: The method of clauses 1-5, wherein the chemical pump usage is determined from a total amount of chemical pumped during the designated period of time.

Clause 7: The method of any of clauses 1-6, wherein the first pump usage set-point is a predetermined upper limit amount of the total chemical pumped during the designated period of time.

Clause 8: The method of any of clauses 1-7, wherein the second pump usage set-point is a predetermined lower limit amount of the total chemical pumped during the designated period of time.

Clause 9: The method of any of clauses 1-8, wherein the chemical feed pump usage is determined from an expected chemical gain in chemical concentration during the designated period of time.

Clause 10: The method of any of clauses 1-9, wherein the first pump usage set-point is a predetermined upper limit amount of the expected chemical gain in chemical concentration during the designated period of time.

Clause 11: The method of any of clauses 1-10, wherein the second pump usage set-point is a predetermined lower limit amount of the expected chemical gain in chemical concentration during the designated period of time.

Clause 12: The method of any of clauses 1-11, wherein the chemical gain is increased by increasing a chemical feed rate of the at least one chemical in the body of water, and wherein the chemical gain is decreased by decreasing the chemical feed rate of the at least one chemical in the body of water.

Clause 13: The method of any of clauses 1-12, wherein the chemical feed rate of the at least one chemical is increased by a predetermined amount when the pump usage is greater than the first pump usage set-point, and wherein the chemical feed rate of the at least one chemical is decreased by a predetermined amount when the pump usage is less than the second pump usage set-point.

Clause 14: The method of any of clauses 1-13, wherein an amount in which the chemical feed rate of the at least one chemical is increased is determined by the following formula: F_{NEW}=MIN(F+DELTA_F_UP, F_MAX), wherein F_{NEW} is the new chemical feed rate, F is the current chemical feed rate, DELTA_F_UP is the increase in the chemical feed rate, and F_MAX is the maximum chemical feed rate.

Clause 15: The method of any of clauses 1-14, wherein an amount in which the chemical feed rate of the at least one chemical is decreased is determined by the following formula: F_{NEW}=MAX(F+DELTA_F_DOWN, F_MIN), wherein F_{NEW} is the new chemical feed rate, F is the current chemical feed rate, DELTA_F_DOWN is the decrease in the chemical feed rate, and F_MIN is the minimum chemical feed rate.

Clause 16: The method of any of clauses 1-13, wherein the chemical feed rate is increased or decreased by an amount to provide a new chemical feed rate that is determined from the following formula: F_{NEW}=K*V/C, in which F_{NEW} is the new chemical feed rate, K is a desired chemical gain of the at least one chemical in the body of water, V is the water volume of the body of water, and C is the concentration of the bulk solution of chemical to the reservoir.

Clause 17: The method of clause 16, wherein the desired chemical gain is determined by the following formula: K=K̅/SP %, in which K is the desired chemical gain, K̅ is an average chemical gain in the body of water over the designated period of time, and SP % is a desired % of pump usage over the designated period of time.

Clause 18: The method of any of clauses 1-17, further comprising notifying an operator when the chemical feed rate of the at least one chemical is increased or decreased and/or when the at least one chemical should increase or decrease.

Clause 19: A system for controlling a feed rate of at least one chemical into a body of water comprising: an assembly for delivering one or more chemicals into the body of water comprising at least one chemical feed pump; a water sampling assembly configured to extract water samples from the body of water at different points in time; an analyzer in fluid communication with the water sampling assembly; a controller in operable communication with the analyzer and the assembly for delivering one or more chemicals; and one or more computer-readable storage mediums in operable communication with the controller and containing programming instructions that, when executed, cause the controller to: a) determine a chemical pump usage of at least one chemical into the body of water during a designated period of time; and b) (i) automatically increase a chemical gain of the at least one chemical in the body water if the pump usage is greater than a first pump usage set-point, or (ii) automatically decrease chemical gain of the at least one chemical in the body water if the pump usage is less than a second pump usage set-point.

Clause 20: The system according to clause 19, wherein the at least one chemical is chlorine.

Clause 21: The system according to clauses 19 or 20, wherein the analyzer comprises a total chlorine analyzer and/or free chlorine analyzer.

Clause 22: The system according to any of clauses 19-21, wherein the controller is configured to notify an operator when the chemical feed rate of the at least one chemical is increased or decreased and/or when the at least one chemical should increase or decrease.

### BRIEF DESCRIPTION OF THE DRAWINGS

FIG. 1 illustrates a system for delivering chemicals into a body of water according to the principles of the present disclosure; and

FIG. 2 illustrates an assembly for dosing a body of water with chemicals according to the principles of the present disclosure.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume alternative variations and step sequences, except where expressly specified to the contrary. It is also to be understood that the specific devices and processes illustrated in the attached drawings, and described in the specification, are simply exemplary embodiments of the disclosure. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

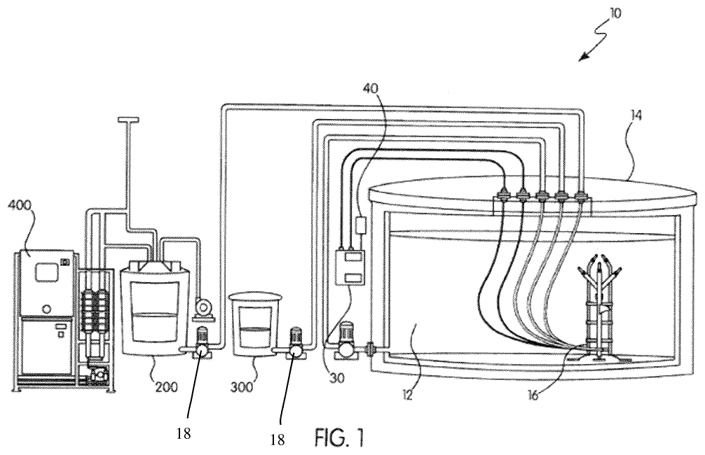

Referring to FIG. 1, and in some non-limiting embodiments or aspects, the present disclosure is directed to a system 10 that can be used to automatically control chemical gain of at least one chemical into a body of water 12 contained in a reservoir 14. The term “automatic control” refers to the absence of substantial participation of a human operator in normal operations manually controlling the controllable components. As such, the system 10 can be controlled without an operator monitoring or adjusting the various parameters of the system 10 during normal operations.

As shown in FIG. 1, the system 10 includes an assembly 16 for delivering one or more chemicals into the body of water 12 and which includes at least one chemical feed pump 18 that controls the distribution of the one or more chemicals. As used herein, a “chemical pump”, “chemical feed pump”, and like terms refer to a pumping device that is capable of feeding chemicals in various forms (e.g., gas and/or liquid chemicals) from a chemical storage source into the body of water 12. For example, the chemical feed pump 18 can include a cylinder and a valve configured to distribute chlorine gas into the body of water 12.

The assembly 16 used with the present disclosure can comprise various assemblies that are configured to control and deliver chemicals into the body of water 12. A non-limiting example of a suitable assembly 16 is illustrated in FIG. 1 and includes a water motive tube 20, a first chemical treatment flow tube 22, and, optionally, a second chemical treatment flow tube 24. It is appreciated that the at least one chemical pump 18 controls the distribution of chemicals through the chemical treatment flow tubes 22, 24 and into the body of water 12.

In some non-limiting embodiments or aspects, the water motive tube 20 and chemical treatment flow tubes 22, 24 of the chemical dosing assembly 16 can be oriented to expel water and chemicals, respectively, into the body of water 12 held in the reservoir 14. The chemicals used with the chemical treatment tubes 22, 24 can include, but are not limited to, chlorine. Other non-limiting examples of chemicals include ammonia. The chemicals can also be selected to form chloramine, such as monochloramine, when expelled into a jet of water expelled from the water motive tube 20. For example, the first chemical treatment flow tube 22 can be in fluid communication with a source of chlorine, such as a reservoir tank 200, and can be configured to expel chlorine into the body of water 12 while the second chemical treatment flow tube 24 can be in fluid communication with a source of ammonia, such as a second reservoir tank 300, and can be configured to expel ammonia into the body of water 12. An on-site hypochlorite generation system 400 could also be used to generate hypochlorite-based chemicals (e.g., sodium hypochlorite or potassium hypochlorite) directly at the water treatment site.

In addition, in some non-limiting embodiments or aspects, the water motive tube 20 is positioned below the release point of the first and second chemical treatment flow tubes 22, 24 to circulate the chemicals into the body of water 12. The flow of water out of the water motive tube 20 can also create a high energy, high velocity mixing zone directly above the water motive tube 20 where the chemicals can be released.

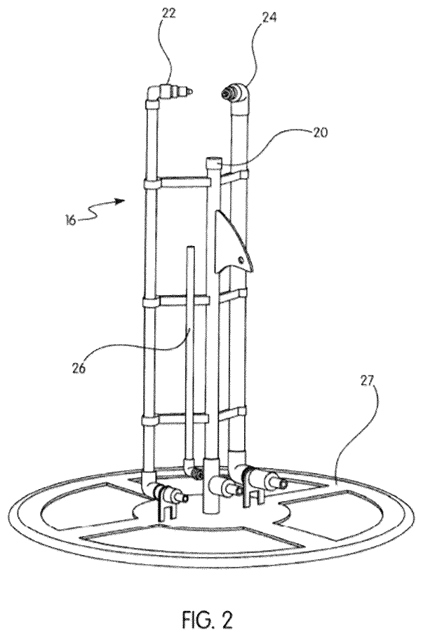

The system 10 also includes a water sampling line 26 that is configured to obtain or extract water samples from the body of water 12 at different points in time, such as continuously, periodically, and/or according to a pre-programmed cycle. As shown in FIG. 2, the water sampling line 26 can be a component of the chemical dosing assembly 16. For example, the water motive tube 20, chemical treatment tubes 22, 24, and water sampling line 26 of the chemical dosing assembly 16 can be secured to a frame 27 that is adapted to rest at the bottom of the reservoir 14. Alternatively, the water motive tube 20, the chemical treatment tubes 22, 24, and the water sampling line 26 can extend into the reservoir 14 to a desired depth. Yet another alternative (not shown) is that the water sampling line 26 can be separate from the chemical dosing assembly 16 and may be located at any location within the reservoir 14.

Referring to FIG. 1, and in some non-limiting embodiments or aspects, the system 10 includes an analyzer 30 that is in fluid communication with the water sampling line 26. The analyzer 30 is configured to receive the water samples and analyze the contents thereof. In some non-limiting embodiments or aspects, the analyzer 30 is programmed or configured to determine the concentration of chlorine and/or chloramine in the water sample. In some non-limiting embodiments or aspects or aspect, the analyzer 30 is, or includes, a chloramine analyzer, such as the APA 6000 Ammonia and Monochloramine Analyzer commercially available from Hach Company of Loveland, CO, which can directly measure the chloramine concentration in the water sample. In another preferred and non-limiting embodiment or aspect, the analyzer 30 is, or includes, a total chlorine analyzer, such as the total chlorine analyzer commercially available from ProMinent Fluid Controls, Inc. of Pittsburgh, PA, and/or a free chlorine analyzer.

As indicated, the system 10 can further include a controller 40 that is in operable communication with the at least one chemical pump 18 to control the chemical gain of chemicals into the body of water 12. The controller 40 is also in operable communication with the analyzer 30 so that measurements and other data gathered, and/or determined by the analyzer 30, can be transferred or accessed by the controller 40. One or more computer-readable storage mediums can be in operable communication with the controller 40. The computer-readable storage mediums can contain programming instructions that, when executed, cause the controller 40 to perform multiple tasks. This includes programming algorithms to control the administration and chemical feed rate of chemicals, such as chlorine and/or ammonia, into the body of water 12. The programming instructions can be updated and modified.

In some non-limiting embodiments or aspects, the programming instructions, when executed, can cause the controller 40 to: determine a chemical feed pump usage of at least one chemical into the body of water 12 during a designated period of time; and (i) automatically increase chemical gain of the at least one chemical into the body of water 12 if the pump usage is greater than a first pump usage set-point, or (ii) automatically decrease chemical gain of the at least one chemical into the body of water 12 if the pump usage is less than a second pump usage set-point. The controller 40 can also be configured to notify an operator when the chemical feed rate of the at least one chemical is increased or decreased and/or when the at least one chemical should increase or decrease. It will be appreciated that controller 40 may include one or more microprocessors, CPUs, and/or other computing devices.

Non-limiting examples of suitable assemblies are also disclosed in U.S. Pat. No. 9,039,902 and United States Patent Application Publication No. 2016/0362318, which are incorporated by reference herein in their entireties. The system 10 can also utilize other mixing systems, as well such as the mixing system disclosed in U.S. Pat. No. 7,862,302, which is incorporated by reference herein in its entirety.

As indicated, the system 10, such as the system previously described, can be used for automatically controlling the chemical gain of at least one chemical into a body of water 12. The method can be implemented through one or more algorithms and controls contained in programming instructions that, when executed, cause the system 10 to take certain actions, as described below.

In some non-limiting embodiments or aspects, the method of the present disclosure dispenses one or more chemicals into a body of water 12. The chemical(s) are dispensed using any of the previously described assemblies 16. Further, the chemicals can be selected from any of the previously described chemicals such as chlorine for example. It is appreciated that the chemical pump 18 and feed rate of the chemicals are controlled by the controller 40 to distribute the chemicals into the body of water 12.

In some non-limiting embodiments or aspects, the controller 40 determines the chemical feed pump 18 usage of at least one chemical into the body of water 12 during a designated period of time. The designated period of time is any desired period of time selected to monitor the chemical pump 18 usage of chemicals into the body of water 12. For example, the designated period of time can be 24 hours in which the controller 40 monitors the amount of time the chemical pump 18 is used.

In some non-limiting embodiments or aspects, the chemical pump 18 usage is calculated as a percentage of time in which the chemical pump 18 is running during the designated period of time. For example, the controller 40 can determine the percentage the chemical pump 18 is running and distributing chemical(s) into the body of water 12 over the entire monitored designated period of time. The percentage of time in which the chemical pump 18 is running can be calculated as follows: (x/y)*(100%), in which x is the period of time the chemical pump 18 is running, and y is the entire designated period of time.

In some non-limiting embodiments or aspects, the chemical pump 18 usage is determined based on the total amount of chemical pumped during the designated period of time. As such, the chemical pump 18 usage can be determined by monitoring the amount of chemical pumped to the reservoir tank 200 or 300.

In some non-limiting embodiments or aspects, the chemical pump 18 usage is determined based on an average gain in chemical feed during the designated period of time. As such, the average chemical gain can be monitored as chemical is pumped into the water reservoir 14 at a certain feed rate and known volume. Based on the average gain during the designated period of time, the pump 18 usage can be determined.

After determining the chemical pump 18 usage of at least one chemical into the body of water 12 during the designated period of time, the programming instructions of the computer-readable storage mediums will cause the controller 40 to: (i) automatically increase the chemical gain of the at least one chemical into the body water 12 if the pump 18 usage is greater than a first pump 18 usage set-point; or (ii) automatically decrease the chemical gain of the at least one chemical into the body of water 12 if the pump 18 usage is less than a second pump 18 usage set-point.

It is appreciated that the first pump 18 usage set-point and the second pump 18 usage set-point are predetermined set-points of the chemical feed pump 18. Further, when the chemical feed pump 18 usage is calculated as a percentage of time in which the chemical feed pump 18 is running during the designated period of time, the first pump 18 usage set-point is an upper limit that indicates if the pump 18 usage is too high and that the chemical feed rate should be increased to lower the pump 18 usage, while the second pump 18 usage set-point is a lower limit that indicates if the pump 18 usage is too low and that the chemical feed rate should be decreased to raise the pump 18 usage. The controller 40, therefore, controls the chemical feed pump 18 so that the chemical feed pump 18 usage is between the first pump 18 usage set-point and the second pump 18 usage set-point.

Further, as used herein, the chemical gain refers to the amount of chemical, such as chlorine, added into the body of water 12 by the chemical feed pump 18. Various factors determine and control the chemical gain including the chemical feed rate of the chemical feed pump 18 as well as fluctuations in water volume. Therefore, the chemical gain into the body of water 12 can be adjusted by increasing or decreasing the chemical feed rate of the chemical pump 18. The chemical gain can also be adjusted by adjusting the water volume that forms the body of water 12.

In some non-limiting embodiments or aspects, the chemical gain is increased by increasing the chemical feed rate of the at least one chemical in the body of water 12, and the chemical gain is decreased by decreasing the chemical feed rate of the at least one chemical in the body of water 12. For example, the chemical feed rate of the at least one chemical can be increased by a predetermined amount when the pump 18 usage is greater than the first pump usage 18 set-point, and the chemical feed rate of the at least one chemical can decreased by a predetermined amount when the pump 18 usage is less than the second pump 18 usage set-point.

In some non-limiting embodiments or aspects, the increase in chemical feed rate can be controlled by the following algorithm: PT>FS=increase chemical feed rate, in which PT is the pump 18 usage time and FS is the first pump 18 usage set-point. Thus, the programming instructions can include the above algorithm that, when satisfied, will cause the controller 40 to automatically increase the chemical feed rate.

In some non-limiting embodiments or aspects, the decrease in chemical feed rate can be controlled by the following algorithm: PT<SS=decrease chemical feed rate, in which PT is the pump 18 usage time and SS is the second pump 18 usage set-point. Thus, the programming instructions can include the above algorithm that, when satisfied, will cause the controller 40 to automatically decrease the chemical feed rate.

In some non-limiting embodiments or aspects, the first pump 18 usage set-point is a predetermined upper limit percentage of the designated period of time. The increase in chemical feed rate based on an upper limit percentage of the designated period of time can be controlled by the following algorithm: PT %>FS %=increase chemical feed rate, in which PT % is the pump 18 usage time percentage and FS % is the first pump 18 usage set-point percentage. Thus, the programming instructions can include the above algorithm that, when satisfied, will cause the controller 40 to automatically increase the chemical feed rate.

In some non-limiting embodiments or aspects, the algorithm that controls the increase in chemical feed rate based on an upper limit percentage of the designated period of time can also be adjusted such that the chemical feed rate is only increased when the pump 18 usage time percentage is above a certain amount of the first pump 18 usage set-point percentage. An example of the adjusted algorithm is as follows: PT %>FS %+X %=increase chemical feed rate, in which PT % is the pump 18 usage time percentage, FS % is the first pump 18 usage set-point percentage, and X % is an additional percentage such as 10%. For instance, the adjusted algorithm can be PT %>FS %+10%=increase chemical feed rate, so that the chemical feed rate is not increased until the pump 18 usage time percentage is 10% over the first pump 18 usage set-point percentage.

The second pump usage set-point can also include a predetermined lower limit percentage of the designated period of time. The decrease in chemical feed rate based on a lower limit percentage of the designated period of time can be controlled by the following algorithm: PT %<SS %=decrease chemical feed rate, in which PT % is the pump 18 usage time percentage and SS % is the second pump 18 usage set-point percentage. Thus, the programming instructions can include the above algorithm that, when satisfied, will cause the controller 40 to automatically decrease the chemical feed rate.

In some non-limiting embodiments or aspects, the algorithm that controls the decrease in chemical feed rate based on a lower limit percentage of the designated period of time can also be adjusted such that the chemical feed rate is only decreased when the pump 18 usage time percentage is below a certain amount of the second pump 18 usage set-point percentage. An example of the adjusted algorithm is as follows: PT %<SS %-X %=decrease chemical feed rate, in which PT % is the pump 18 usage time percentage, SS % is the second pump 18 usage set-point percentage, and X % is an additional percentage such as 10%. For instance, the adjusted algorithm can be PT %<SS %-10%=decrease chemical feed rate, so that the chemical feed rate is not decreased until the pump 18 usage time percentage is 10% under the second pump 18 usage set-point percentage.

It is appreciated that the first pump 18 usage set-point percentage and second pump 18 usage set-point percentage can be determined as follows: FS %=(FS/y)*(100%), in which FS % is the first pump 18 usage set-point percentage, FS is the first pump 18 usage set-point for running the chemical feed pump 18, and y is the entire designated period of time; and SS %=(SS/y) *(100%), in which SS % is the second pump 18 usage set-point percentage, SS is the second pump 18 usage set-point for running the chemical feed pump 18, and y is the entire designated period of time.

As indicated, the controller 40 can increase or decrease the chemical feed rate based on the pump 18 usage previously described. In some non-limiting embodiments or aspects, the chemical feed rate of the at least one chemical is increased by a predetermined amount when the pump 18 usage is greater than the first pump 18 usage set-point or set-point percentage. Similarly, in some non-limiting embodiments or aspects, the chemical feed rate of the at least one chemical is decreased by a predetermined amount when the pump usage is less than the second pump usage set-point or set-point percentage.

In some non-limiting embodiments or aspects, the controller 40 will increase or decrease the chemical feed rate based on a calculated amount. In some non-limiting embodiments or aspects, the controller 40 will increase the chemical feed rate by an amount as determined as follows: F_{NEW}=MIN(F+DELTA_F_UP, F_MAX), in which F_{NEW} is the new chemical feed rate, F is the current chemical feed rate, DELTA_F_UP is the increase in the chemical feed rate, and F_MAX is the maximum chemical feed rate. Thus, the programming instructions can include the above algorithm that will cause the controller 40 to increase the chemical feed rate by the calculated amount.

In some non-limiting embodiments or aspects, the controller 40 will decrease the chemical feed rate by an amount as determined as follows: F_{NEW}=MAX(F+DELTA_F_DOWN, F_MIN), in which F_{NEW} is the new chemical feed rate, F is the current chemical feed rate, DELTA_F_DOWN is the decrease in the chemical feed rate, and F_MIN is the minimum chemical feed rate. Thus, the programming instructions can include the above algorithm that will cause the controller 40 to decrease the chemical feed rate by the calculated amount.

In some non-limiting embodiments or aspects, the chemical feed rate is increased or decreased by an amount to provide a new chemical feed rate based on a desired chemical gain into the body of water 12, the volume of water that forms the body of water 12, and the chemical concentration of the at least one chemical (e.g., chlorine). In some non-limiting embodiments or aspects, the new chemical feed rate is determined from the following formula: F_{NEW}=K*V/C, in which F_{NEW} is the new chemical feed rate, K is a desired chemical gain of the at least one chemical in the body of water 12, V is the water volume of the body of water 12, and C is the concentration of the bulk solution of chemical to the reservoir 14. In some non-limiting embodiments or aspects, the desired chemical gain is determined by the following formula: K=K̅/SP %, in which K is the desired chemical gain, K̅ is an average chemical gain in the body of water 12 over the designated period of time, and SP % is a desired % of pump usage over the designated period of time.

The method of the present disclosure can also include additional steps. For instance, the method can further include a step of notifying an operator when the chemical feed rate of the at least one chemical is increased or decreased and/or when the at least one chemical should increase or decrease. The notification can also be transmitted to an offsite facility to notify an operator.

The method and system 10 can further include other steps and controls such as steps and controls used during a water treatment process. For example, the system 10 and method of the present disclosure can also be used to control the administration of chemicals into the body of water 12 using additional algorithms and method steps such as disclosed in United States Patent Application Publication No. 2016/0362318, which is incorporated by reference herein in its entirety.

Whereas particular embodiments of this disclosure have been described above for purposes of illustration, it will be evident to those skilled in the art that numerous variations of the details of the present disclosure may be made without departing from the disclosure as defined in the appended claims.

What is claimed is:

1. A system for controlling a feed rate of at least one chemical into a body of water comprising:
an assembly for delivering at least one chemical into a reservoir containing the body of water comprising at least one chemical feed pump;
a water sampling assembly configured to extract water samples from the body of water at different points in time;
an analyzer in fluid communication with the water sampling assembly;
a controller in operable communication with the analyzer and the assembly for delivering one or more chemicals; and
a computer-readable storage medium in operable communication with the controller and containing programming instructions that, when executed, cause the controller to:
a) determine a chemical feed pump usage of at least one chemical being dispensed into the body of water during a designated period of time with the controller, wherein the at least one chemical is dispensed into the body of water with the at least one chemical feed pump and one or more chemical treatment flow tubes that extend between one or more chemical storage tanks and the reservoir; and
b) (i) automatically increase a chemical gain of the at least one chemical in the body water if the pump usage is greater than a first pump usage set-point, or (ii) automatically decrease chemical gain of the at least one chemical in the body water if the pump usage is less than a second pump usage set-point, wherein the chemical gain is increased by increasing the chemical feed rate of the at least one chemical from the chemical feed pumping device into the body of water, and wherein the chemical gain is decreased by decreasing the chemical feed rate of the at least one chemical from the chemical feed pump into the reservoir.

2. The system according to claim 1, wherein the at least one chemical is chlorine.

3. The system according to claim 1, wherein the analyzer comprises a total chlorine analyzer and/or free chlorine analyzer.

4. The system according to claim 1, wherein the controller is configured to notify an operator when the chemical feed rate of the at least one chemical is increased or decreased and/or when the at least one chemical should increase or decrease.

5. The system according to claim 1, wherein the chemical feed pump usage is a percentage of time in which the chemical feed pumping device is running during the designated period of time.

6. The system according to claim 5, wherein the first pump usage set-point is a predetermined upper limit percentage of the designated period of time.

7. The system according to claim 5, wherein the second pump usage set-point is a predetermined lower limit percentage of the designated period of time.

8. The system according to claim 1, wherein the chemical feed pump usage is determined from a total amount of the at least one chemical pumped during the designated period of time.

9. The system according to claim 8, wherein the first pump usage set-point is a predetermined upper limit of a total amount of the at least one chemical pumped during the designated period of time.

10. The system according to claim 8, wherein the second pump usage set-point is a predetermined lower limit of a total amount of the at least one chemical pumped during the designated period of time.

11. The system according to claim 1, wherein the chemical pump usage is determined from an expected chemical gain in chemical concentration of the at least one chemical during the designated period of time.

12. The system according to claim 11, wherein the first pump usage set-point is a predetermined upper limit amount of the expected chemical gain in chemical concentration of the at least one chemical during the designated period of time.

13. The system according to claim 11, wherein the second pump usage set-point is a predetermined lower limit amount of the expected chemical gain in chemical concentration of the at least one chemical during the designated period of time.

14. The system according to claim 1, wherein the chemical feed rate of the at least one chemical is increased by a pre-determined amount when the pump usage is greater than the first pump usage set-point, and wherein the chemical feed rate of the at least one chemical is decreased by a pre-determined amount when the pump usage is less than the second pump usage set-point.
